(19) United States
(12) Patent Application Publication
(10) Pub. No.: US 2014/0099988 A1
(43) Pub. Date: Apr. 10, 2014

(54) METHOD AND APPARATUS FOR CONTROLLING TRANSMISSION POWER OF MULTIPLE UPLINK CHANNELS IN THE SAME FREQUENCY BAND

(71) Applicant: QUALCOMM Incorporated, San Diego, CA (US)

(72) Inventors: Surendra Boppana, San Diego, CA (US); Insung Kang, San Diego, CA (US); Aamod Dinkar Khandekar, San Diego, CA (US)

(21) Appl. No.: 13/916,206

(22) Filed: Jun. 12, 2013

Related U.S. Application Data
(60) Provisional application No. 61/711,652, filed on Oct. 9, 2012.

(51) Int. Cl. H04W 52/24; H04W 52/10

(52) U.S. Cl. CPC H04W 52/243; H04W 52/10
USPC 455/522

(57) ABSTRACT

A method and apparatus for controlling transmission power of multiple uplink channels in the same frequency band is described. A first uplink channel may be established with a base station. A second uplink channel may be established with the base station. The first uplink channel and the second uplink channel may be in one timeslot and in the same frequency band. A difference between a transmission power of the first uplink channel and a transmission power of the second uplink channel may be calculated. The transmission power of the first uplink channel and transmission power of the second uplink channel may be individually adjusted based on the calculated difference.

### CLAIM OF PRIORITY UNDER 35 U.S.C. §119

The present Application for Patent claims priority to Provisional Application No. 61/711,652 entitled “UPLINK POWER CONTROL MECHANISM” filed Oct. 9, 2012, and assigned to the assignee hereof and hereby expressly incorporated by reference herein.

### BACKGROUND

1. Field

Aspects of the present disclosure relate generally to wireless communication systems, and more particularly, to controlling transmission power of multiple uplink channels in the same frequency band.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

In the TD-SCDMA standard, two physical channels may be provided in an uplink (UL) time slot. The two uplink channels may be independently power-controlled, which could, at times, lead to significant power differences between the two UL channels. Such a power difference may result in degraded performance at the base station (also referred to as a Node B).

Therefore, improvements in controlling transmission power of multiple uplink channels in the same frequency band are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method for controlling transmission power of uplink channels is described. The method may include establishing a first uplink channel with a base station. The method may include establishing a second uplink channel with the base station. The first uplink channel and the second uplink channel may be in one timeslot and in the same frequency band. The method may include calculating a difference between a transmission power of the first uplink channel and a transmission power of the second uplink channel. The method may include individually adjusting transmission power of the first uplink channel and transmission power of the second uplink channel based on the calculated difference.

In an aspect, a computer program product for controlling transmission power of uplink channels is described. The computer program product may include a computer-readable medium including code. The code may cause a computer to establish a first uplink channel with a base station. The code may cause a computer to establish a second uplink channel with the base station. The first uplink channel and the second uplink channel may be in one timeslot and in the same frequency band. The code may cause a computer to calculate a difference between a transmission power of the first uplink channel and a transmission power of the second uplink channel. The code may cause a computer to individually adjust transmission power of the first uplink channel and transmission power of the second uplink channel based on the calculated difference.

In an aspect, an apparatus for controlling transmission power of uplink channels is described. The apparatus may include means for establishing a first uplink channel with a base station. The apparatus may include means for establishing a second uplink channel with the base station. The first uplink channel and the second uplink channel may be in one timeslot and in the same frequency band. The apparatus may include means for calculating a difference between a transmission power of the first uplink channel and a transmission power of the second uplink channel. The apparatus may include means for individually adjusting transmission power of the first uplink channel and transmission power of the second uplink channel based on the calculated difference.

In an aspect, an apparatus for controlling transmission power of uplink channels is described. The apparatus may include at least one memory. The apparatus may include an uplink channel establishment module configured to establish a first uplink channel with a base station, and establish a second uplink channel with the base station. The first uplink channel and the second uplink channel may be in one timeslot and in the same frequency band. The apparatus may include a calculation module configured to calculate a difference between a transmission power of the first uplink channel and a transmission power of the second uplink channel. The apparatus may include an adjustment module configured to individually adjust transmission power of the first uplink channel and transmission power of the second uplink channel based on the calculated difference.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating an example of a telecommunications system, including a user equipment (UE) and a base station;

FIG. 2 is a flow chart illustrating an example of a method for controlling transmission power of two uplink (UL) channels, according to aspects of the present disclosure;

FIGS. 3 and 4 are a flow chart illustrating an example of a method for controlling transmission power of two UL channels, in a particular, non-limiting example, according to aspects of the present disclosure;

FIG. 5 is a diagram illustrating an example of a hardware implementation for an apparatus employing a processing system according to one aspect of the present disclosure

FIG. 6 is a block diagram illustrating an example of a telecommunications system;

FIG. 7 is a block diagram illustrating an example of a frame structure in a telecommunications system; and

FIG. 8 is a block diagram illustrating an example of a Node B in communication with a UE in a telecommunications system;

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

TD-SCDMA uses a separate power control mechanism for uplink (UL) channels (e.g., a dedicated physical channel (DPCH)) and enhanced high speed channel (e.g., a high-speed shared information channel (HS-SICH)). Other channel combinations may include, DPCH and enhanced random-access uplink control channel (ERUCCH) or enhanced physical uplink control channel (EPUCH) and HS-SICH. Each UL channel may transmit at different power levels based on their respective power control set by a base station in communication with a user equipment (UE). More specifically, a base station may separately control the power of each channel individually (e.g., UL channel and enhanced high speed channel). When the difference in the power levels for each channel is greater than a threshold, the base station may experience difficulty decoding the UL channel and/or the enhanced high speed channel. As a result of not being able to decode a channel, a call may be dropped or the network may experience a lower throughput. Furthermore, a significant difference in the power levels of two channels may result in a low Signal-to-Quantization-Noise Ratio (SQNR) for the weaker channel at the UE side.

Typically, and in a non-limiting example, a dynamic range for channels received by a base station is between −70 dBm and −105 dBm, where dBm represents a power ratio in decibels (dB) of measured power to one milliwatt (mW). Accordingly, the power difference between an UL channel and an enhanced high speed channel, which may occupy the same time slot in the same frequency band, may theoretically reach 72 dBm. As a base station's receive adaptive gain control (AGC) dynamic range is typically limited, most base stations may have difficulties reliably decoding a signal that is more than 10 dBm weaker than a stronger channel that shares the same time slot and is in the same frequency band.

According to aspects of the present disclosure, a UE may reduce the difference in transmit power between the UL channel and enhanced high speed channel so that the base station may accurately decode the UL channel.

According to one aspect, the UE may determine the transmit power level for the uplink channel, such as DPCH, and the transmit power level for the enhanced high speed channel, such as SICH, and reduce the power difference when the power difference is greater than a threshold.

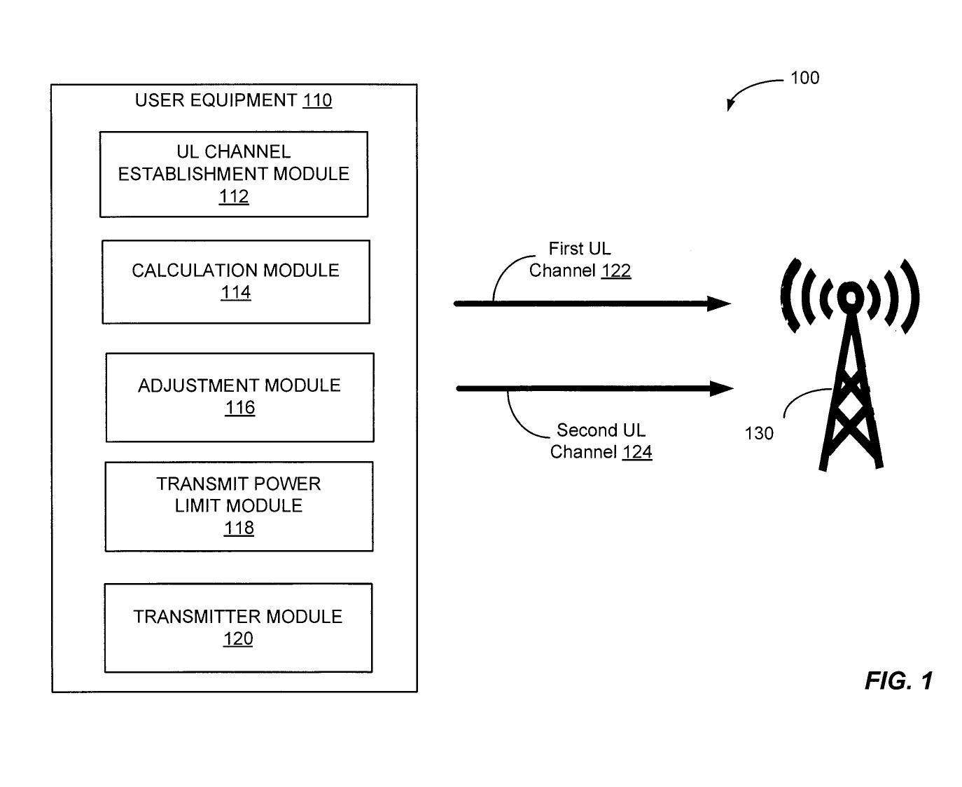

Referring to FIG. 1, a telecommunication system 100 includes a user equipment (UE) 110 in communication with a base station 130. UE 110 may be referred to as a mobile apparatus, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

Base station 130 may be a macrocell, picocell, femtocell, relay, Node B, mobile Node B, UE (e.g., communicating in peer-to-peer or ad-hoc mode with UE 110), or substantially any type of component that can communicate with UE 110 to provide wireless network access.

UE 110 includes a UL channel establishment module 112, which may be configured to establish uplink channels between the UE 110 and the base station 130. For example, UL channel establishment module 112 may be configured to establish first UL channel 122 and second UL channel 124, such as via a channel establishment procedure. For instance, first UL channel 122 and second UL channel 124 may be a dedicated physical channel (DPCH) and an enhanced high speed channel (e.g., a high-speed shared information channel (HS-SICH), a DPCH and an enhanced random-access uplink control channel (ERUCCH), or an enhanced physical uplink control channel (EPUCH) and an HS-SICH. Also, for example, first UL channel 122 and second UL channel 124 may be in the same timeslot and in the same frequency band.

UE 110 includes calculation module 114, which may be configured to calculate a difference between a transmission power of the first UL channel 122 and a transmission power of a second UL channel 124. Calculation module 114 may be configured, in an aspect, to determine transmission power of the UL channels 122 and 124, and/or, in another aspect, receive information related to transmission power of the UL channels 122 and 124 from some other source. Calculation module 114 may be configured to determine whether the calculated difference is above or below a threshold value. In an aspect, base station 130 may have improved channel decoding when the power difference between the two UL channels 122 and 124 is less than or equal to the threshold value. In a non-limiting example, the threshold value may be 9 dBm.

UE 110 includes adjustment module 116, which may be configured to individually adjust transmission power of the first UL channel 122 and the second UL channel 124 based on the difference in transmission power between the two UL channels 122 and 124 calculated by the calculation module 114. In an aspect, adjustment module 116 may be configured to set the transmission power of the first UL channel 122 to a first pre-determined power level and set the transmission power of the second UL channel 124 to a second pre-determined power level. As such, the first UL channel 122 and second UL channel 124 may be placed, by the adjustment module 116, into open-loop power control. Adjustment module 116 may be configured to put the first UL channel 122 and/or second UL channel 124 into open-loop power control if the first UL channel 122 and/or the second UL channel 124 are newly-established channels.

In an aspect, adjustment module 116 may be configured to determine whether first UL channel 122 and/or second UL channel 124 are newly-established UL channels by, for example, communicating with UL channel establishment module 112, communicating with base station 130, and/or some other source or component. In another aspect, adjustment module 116 may determine whether first UL channel 122 and/or second UL channel 124 are newly-established channels without information from another component.

Open-loop power control includes a procedure in which the UE transmitter sets its output power to a specific value (e.g., a pre-determined power level). Open-loop power control is used for setting initial UL (and downlink (DL)) transmission powers when a UE is first accessing the network. In other words, a pre-determined power level may be used to power control a newly-established channel because there is not yet a history of power transmission information that may be used to power control the UL channel going forward (e.g., to create a closed-loop power control). Closed-loop power control (also referred to as inner-loop power control) in the UL includes a procedure in which the UE transmitter adjusts its output power in accordance with one or more Transmit Power Control (TPC) commands received in the DL, in order to keep the received uplink Signal-to-Interference Ratio (SIR) at a given SIR target. When multiple UL channels are in the same time slot and frequency band, it is desirable that the SIR and/or Signal-to-Interference-Plus-Noise (SINR) targets for the two channels (open-loop and closed-loop) be substantially similar.

First UL channel 122 and second UL channel 124 may be in any combination of open-loop power controlled and closed-loop power controlled when they are individually power controlled or adjusted. In an example, if first UL channel 122 has been previously-established, it may be in closed-loop power control, while second UL channel 124 may be newly-established, and, as such, may be in open-loop power control, or vice versa. In another example, both UL channels 122 and 124 may be in open-loop power control (e.g., both UL channels 122 and 124 are newly-established) or both UL channels 122 and 124 may be in closed-loop power control (e.g., neither UL channel 122 and 124 is newly-established).

In an aspect, adjustment module 116 may be configured to decrease the transmission power of an open-loop power controlled channel (e.g., first UL channel 122 or second UL channel 124), when the stronger of the two UL channels (e.g., first UL channel 122 or second UL channel 124) is in open-loop power control. In a non-limiting example, the transmission power of the open-loop power controlled channel (e.g., the stronger channel) may be decreased to within 3 dBm of the weaker channel. In the aspect, closed-loop channels may be trusted more than open-loop channels. That is, power control has been applied to closed-loop channels for a time period while open-loop channels may not have been power controlled. Thus, power level of a closed-loop channel may be maintained while the power level of an open-loop channel may be decreased.

In an aspect, if the difference in power transmission is greater than a first threshold, as determined by calculation module 114, adjustment module 116 may be configured to adjust (e.g., increase) the transmission power of the weaker UL channel so that a calculated difference in transmission power between the two UL channels is less than, or equal to, the threshold.

In an aspect, if the difference in power transmission is greater than a first threshold, as determined by calculation module 114, adjustment module 116 may be configured to adjust (e.g., decrease) the transmission power of the stronger UL channel so that a calculated difference in transmission power between the two UL channels is less than, or equal to, a second threshold. The second threshold may or may not be related to the first threshold.

In an aspect, adjustment module 116 may be configured to individually adjust the transmission power of the first UL channel 122 and the second UL channel 124 based on a type of channel of each. For example, and as described herein, first UL channel 122 and second UL channel 124 may be a dedicated physical channel (DPCH) and an enhanced high speed channel (e.g., a high-speed shared information channel (HS-SICH), a DPCH and an enhanced random-access uplink control channel (ERUCCH), or an enhanced physical uplink control channel (EPUCH) and an HS-SICH.

Adjustment module 116 and/or calculation module 114 may be configured to re-calculate the difference in transmission power between the two UL channels, after adjusting the transmission power of the weaker and/or stronger channel. If the difference is still greater than the first threshold value, the adjustment module 116 may be configured to further adjust the weaker and/or stronger signal.

Additionally, in an aspect, UE 110 includes transmit power limit module 118, which may be configured to determine an instantaneous transmit power limit of UE 110. The instantaneous transmit power limit is a difference between a maximum transmit power level (MTPL) of UE 110 and a maximum power ratio (MPR) of UE 110. In an aspect, transmit power limit module 118 may be configured to determine the instantaneous transmit power limit of UE 110 based on the maximum transmit power level and the maximum power ratio of UE 110. In another aspect, UE 110 and/or transmit power limit module 118 may be configured to receive information related to an instantaneous transmit power limit of UE 110, a maximum transmit power level of UE 110, and/or a maximum power ratio of UE 110, from some other component or source.

In an aspect, adjustment module 116 may be configured to set the transmission power of the first UL channel 122 and the transmission power of the second UL channel 124 to be equal to or less than the instantaneous transmit power limit determined by transmit power limit module 118.

In an aspect, adjustment module 116 may be configured to determine, and apply, a backoff to first UL channel 122 and/or second UL channel 124 in order to maintain a particular transmission power level of first UL channel 122 and/or second UL channel 124. For example, data channels may be given a lower priority than voice channels. Therefore, transmission power levels of voice channels may be selectively maintained while transmission power of another UL channel, such as a data channel, may be adjusted via a backoff.

In another example, if first UL channel 122 is DPCH, the transmission power level of the first UL channel 122 may be maintained for extended periods of time. As such, and in the example, it may be desirable to apply a backoff on another uplink channel, e.g., second UL channel 124. More particularly, if the transmission power of DPCH (e.g., first UL channel 122) is greater than the maximum UE transmit power (e.g., DPCH_Pwr=23 dBm), adjustment module 116 may be configured to set transmission power of DPCH (e.g., first UL channel 122) to the maximum UE transmit power (e.g., DPCH_Pwr=23 dBm) and set the non-DPCH UL channel (e.g., second UL channel 124) to the minimum UE transmit power (e.g., non_DPCH_Pwr=−7 dBm). In this non-limiting example, although the difference in transmission power between the two UL channels will be greater than some value (e.g., 9 dBm), the non-DPCH UL channel is transmitted at 30 dBm below the transmission power of the DPCH. As such, DPCH quality is maintained with a minimal impact to total transmission power of UE 110. In another example, if first UL channel 122 is ERUCCH, and second UL channel 124 is a non-ERUCCH UL channel, a similar analysis and logic may be applied to protect the quality of ERUCCH.

Further, UE 110 includes transmitter module 120, which may be configured to transmit information on first UL channel 122 and/or second UL channel 124. Transmitter module 120 may be configured to communicate with adjustment module 116 to determine a transmission power for first UL channel 122 and/or second UL channel 124.

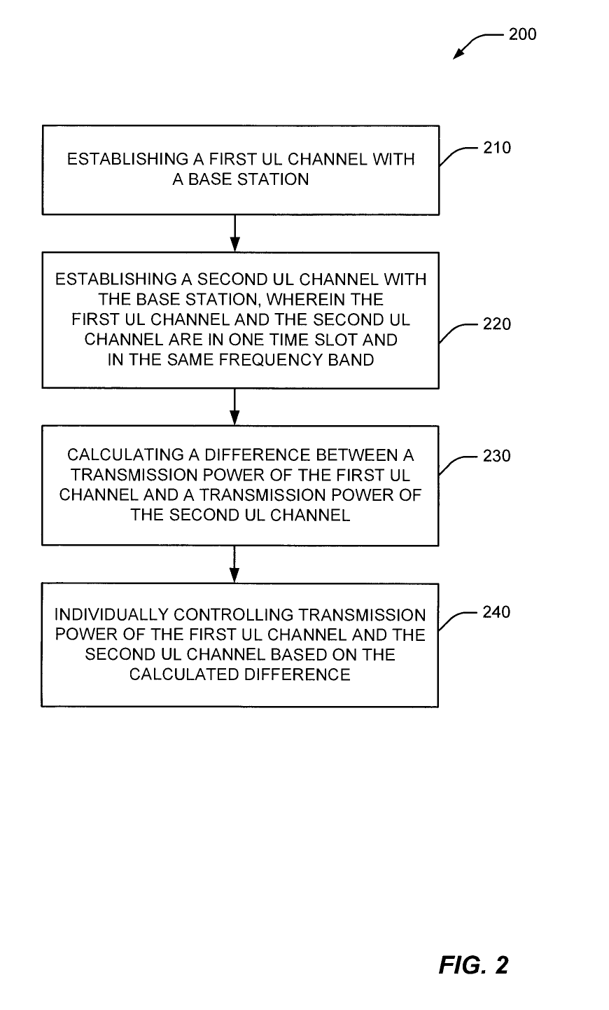

Referring to FIG. 2, a method 200 for controlling transmission power of multiple uplink (UL) channels in the same frequency band, according to one aspect of the present disclosure, is shown. Aspects of method 200 may be performed by UE 110, UL channel establishment module 112, calculation module 114, adjustment module 116, transmit power limit module 118, transmitter module 120, or any combination thereof.

At 210, the method 200 includes establishing a first uplink channel with a base station. For example, UL channel establishment module 112 may establish a first UL channel 122 with base station 130 of FIG. 1.

At 220, the method 200 includes establishing a second uplink channel with the base station, wherein the first uplink channel and the second uplink channel are in one timeslot and in the same frequency band. For example, UL channel establishment module 112 may establish a second UL channel 124 with base station 130 of FIG. 1. First UL channel 122 and second UL channel 124 may be in the same time slot and in the same frequency band.

At 230, the method 200 includes calculating a difference between a transmission power of a first uplink channel and a transmission power of a second uplink channel. For example, calculation module 114 may be configured to determine, or otherwise detect, a transmission power of first UL channel 122 and a transmission power of second UL channel 124, and calculate a difference therebetween.

At 240, the method 200 includes individually adjusting transmission power of the first uplink channel and the second uplink channel based on the calculated difference. For example, adjustment module 116 may be configured to communicate with calculation module 114 to determine the calculated difference in transmission power between first UL channel 122 and second UL channel 124. Adjustment module 116 also may be configured to individually power control, or adjust, the transmission power of first UL channel 122 and/or second UL channel 124 as described herein.

In an aspect, adjustment module 116 may be configured to communicate with UL channel establishment module 112, or some other component, to determine if first UL channel 122 and/or second UL channel 124 is a newly-established channel. If so, adjustment module 116 may be configured to open-loop power control the newly-established channel by setting the transmission power of the newly-established channel to a pre-determined power level.

In an aspect, adjustment module 116 may be configured to individually control, or adjust, transmission power of first UL channel 122 and/or second UL channel 124 based on whether the UL channels are open-loop power controlled or closed-loop power controlled.

In an aspect, adjustment module 116 may be configured to individually control, or adjust, transmission power of first UL channel 122 and/or second UL channel 124 based on a type of first UL channel 122 and a type of second UL channel 124. For example, and as described herein, first UL channel 122 and second UL channel 124 may be a dedicated physical channel (DPCH) and an enhanced high speed channel (e.g., a high-speed shared information channel (HS-SICH), a DPCH and an enhanced random-access uplink control channel (ERUCCH), or an enhanced physical uplink control channel (EPUCH) and an HS-SICH.

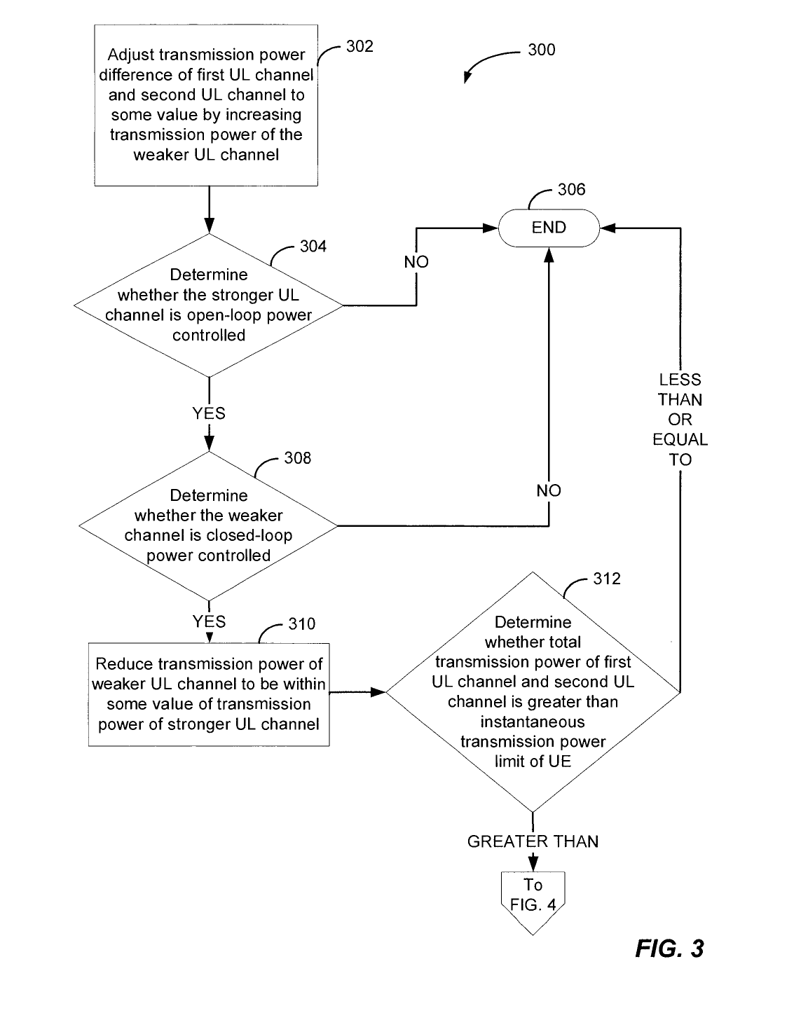

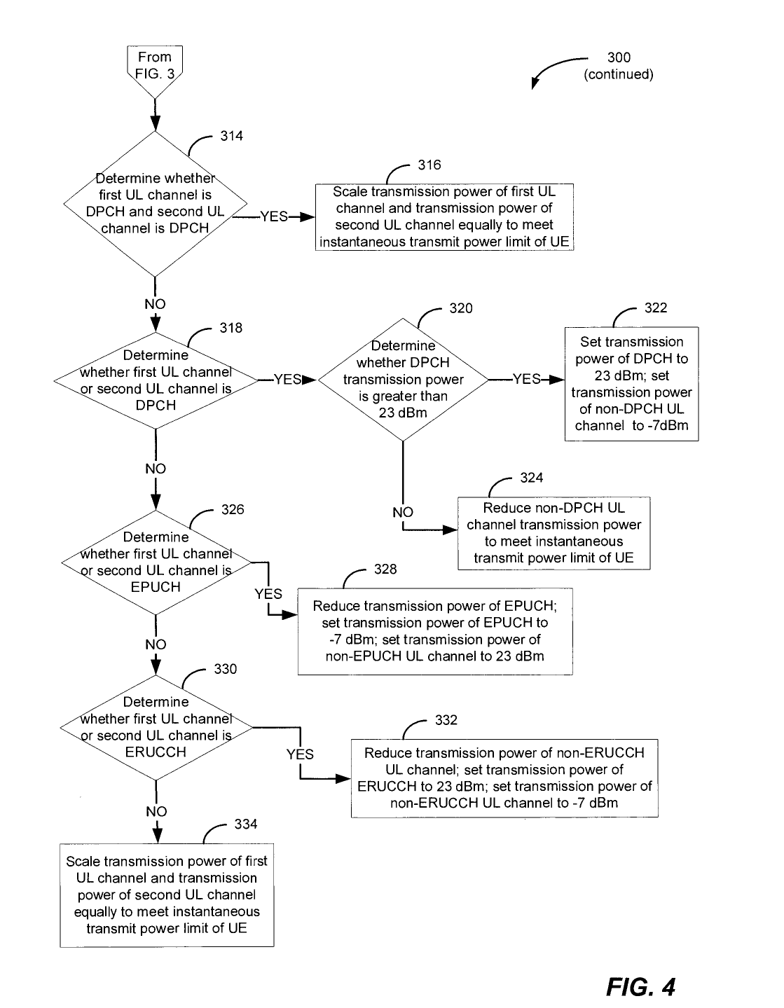

FIGS. 3 and 4 are a flow chart of an aspect of a method 300 for controlling transmission power of first UL channel 122 and/or second UL channel 124, according to the present aspects. In an aspect, method 300 provides additional aspects and details of method 200 of FIG. 2, and is described with respect to a particular, non-limiting example. Aspects of method 300 may be performed by UE 110, calculation module 114, adjustment module 116, transmit power limit module 118, or any combination thereof, for controlling transmission power of first UL channel 122 and/or second UL channel 124.

Referring to FIG. 3, at 302, method 300 includes adjusting a transmission power difference of a first UL channel 122 and a second UL channel 124 to some value (e.g., a pre-determined power level) by increasing transmission power of the weaker UL channel. For example, the first UL channel 122 may be the stronger UL channel and, as such, the second UL channel 124 may be the weaker UL channel. In the example, which is non-limiting, the value may be 9 dBm, and, as such, adjustment module 116 may increase the transmission power of second UL channel 124 to be within 9 dBm of the transmission power of first UL channel 122.

At 304, method 300 includes determining whether the stronger UL channel (e.g., first UL channel 122) is open-loop power controlled. If not, the method 300 terminates at 306. If the stronger UL channel (e.g., first UL channel 122) is open-loop power controlled, at 308, the method 300 includes determining whether the weaker channel is closed-loop power controlled. If not, the method 300 terminates at 306. For example, calculation module 114 and/or adjustment module 116 may determine which of the UL channels (e.g., first UL channel 122 and second UL channel 124) is the weaker channel and which is the stronger channel.

If the weaker UL channel (e.g., second UL channel 124) is closed-loop power controlled, at 310, the method 300 includes reducing transmission power of the weaker UL channel (e.g., second UL channel 124) to be within some value of the transmission power of the stronger UL channel (e.g., first UL channel 122). In a non-limiting example, the value may be 3 dBm, and, as such, adjustment module 116 may decrease the transmission power of first UL channel 122 to be within 3 dBm of second UL channel 124.

At 312, the method 300 includes determining whether a total transmission power of first UL channel 122 and second UL channel 124 (e.g., first UL channel 122_pwr+second UL channel 124_pwr) is greater than an instantaneous transmission power limit of UE 110. In an aspect, transmit power limit module 118 may be configured to determine an instantaneous transmission power limit of UE 110 by determining a difference between a maximum transmit power level (MTPL) of UE 110 and a maximum power ratio (MPR) of UE 110. If the total transmission power of first UL channel 122 and second UL channel 124 is less than or equal to the instantaneous transmission power limit of UE 110, the method 300 terminates at 306. If the total transmission power of first UL channel 122 and second UL channel 124 is greater than the instantaneous transmission power limit of UE 110, the method 300 continues in FIG. 3. For example, calculation module 114, adjustment module 116, and/or transmit power limit module 118 may determine whether the total transmission power of first UL channel 122 and second UL channel 124 is greater than the total transmission power limit of UE 110.

Referring to FIG. 4, at 314, the method 300 includes determining whether first UL channel 122 is DPCH and second UL channel 124 is DPCH. If yes, at 316, the method 300 includes scaling transmission power of first UL channel 122 and transmission power of second UL channel 124 equally to meet and/or does not exceed the instantaneous transmit power limit of UE 110. For example, adjustment module 116 may be configured to communicate with transmit power limit module 118 to determine the instantaneous transmit power limit of UE 110 and, if first UL channel 122 and second UL channel 124 are both DPCH, adjust the transmission power of both UL channels equally to match the instantaneous transmit power limit of UE 110.

If first UL channel 122 and second UL channel 124 are not DPCH, at 318, the method 300 includes determining whether first UL channel 122 or second UL channel 124 is DPCH. In other words, the method 300 includes determining whether DPCH exists at UE 110. If so, at 320, the method 300 includes determining whether DPCH transmission power (e.g., transmission power of whichever of first UL channel 122 or second UL channel 124 is DPCH) is greater than some value. In a non-limiting example, the value may be 23 dBm. For example, adjustment module 116 may be configured to compare DPCH transmission power to a value, such as the non-limiting example of 23 dBm, and set transmission power of first UL channel 122 and second UL channel 124 accordingly.

If, in the non-limiting example, DPCH transmission power is greater than 23 dBm, at 322, the method 300 includes setting transmission power of DPCH to 23 dBm and setting transmission power of the non-DPCH UL channel (e.g., whichever of first UL channel 122 and second UL channel 124 is not DPCH) to −7 dBm. If DPCH transmission power is not greater than the value, (e.g., 23 dBm in the present, non-limiting example), at 324, the method 300 includes reducing the non-DPCH UL channel transmission power to meet and/or does not exceed the instantaneous transmit power limit of UE 110. In an aspect, adjustment module 116 may be configured to adjust transmission power of both DPCH and non-DPCH UL channels so that total transmission power of the two UL channels meets and/or does not exceed the instantaneous transmit power limit of UE 110.

If neither first UL channel 122 nor second UL channel 124 is DPCH (e.g., DPCH does not exist at UE 110), at 326, the method 300 includes determining whether first UL channel 122 or second UL channel 124 is EPUCH. If one of first UL channel 122 and second UL channel 124 is EPUCH, at 328, the method 300 includes reducing transmission power of EPUCH and not adjusting transmission power of the non-EPUCH UL channel. As such, and in a non-limiting example, adjustment module 116 may set transmission power of EPUCH to −7 dBm and set transmission power of the non-EPUCH UL channel to 23 dBm.

If neither first UL channel 122 nor second UL channel 124 is EPUCH (e.g., EPUCH does not exist at UE 110), at 330, the method 300 includes determining whether first UL channel 122 or second UL channel 124 is ERUCCH. If one of first UL channel 122 or second UL channel 124 is ERUCCH, at 332, the method 300 includes reducing transmission power of non-ERUCCH UL channel and not adjusting transmission power of ERUCCH. As such, and in a non-limiting example, adjustment module 116 may set transmission power of ERUCCH to 23 dBm and set transmission power of the non-ERUCCH UL channel to −7 dBm.

If neither first UL channel 122 nor second UL channel 124 is ERUCCH (e.g., ERUCCH does not exist at UE 110), at 334, the method 300 includes scaling transmission power of first UL channel 122 and second UL channel 124 equally to meet and/or does not exceed instantaneous transmit power limit of UE 110. For example, adjustment module 116 may be configured to communicate with transmit power limit module 118 to determine the instantaneous transmit power limit of UE 110 and, if first UL channel 122 and second UL channel 124 are both DPCH, adjust the transmission power of both UL channels equally to meet and/or not exceed the instantaneous transmit power limit of UE 110.

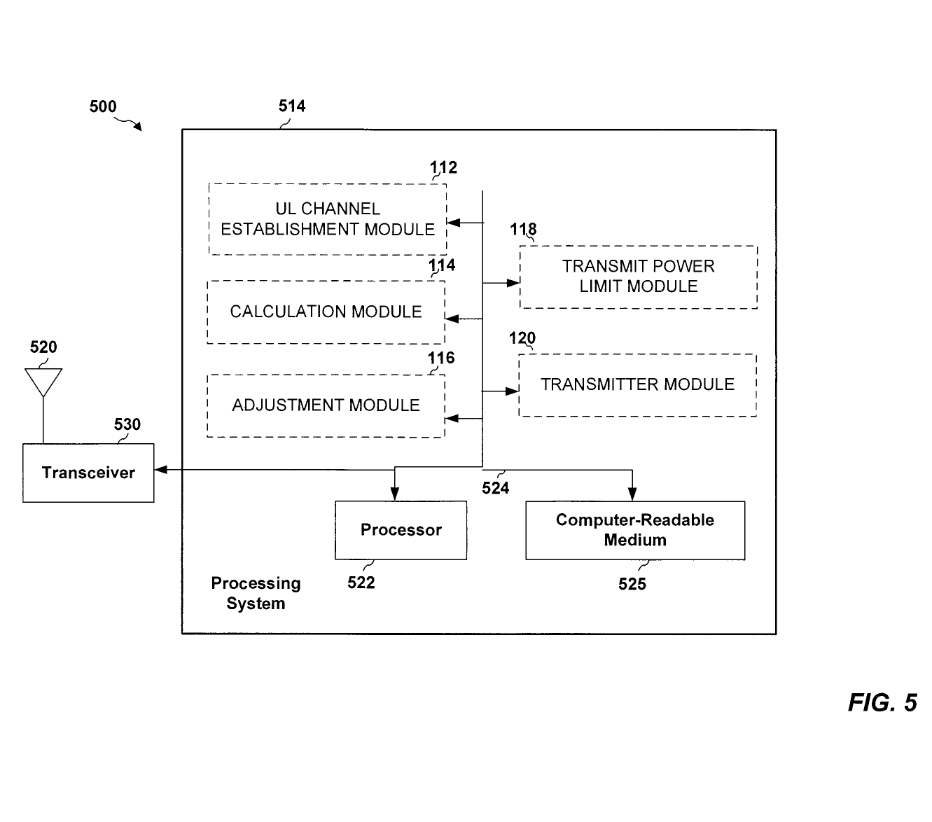

FIG. 5 is a diagram illustrating an example of a hardware implementation for an apparatus 500 employing a processing system 514. In an aspect, the apparatus 500 may be part of UE 110 and/or may include any combination of the above-described components thereof.

The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware modules, represented by processor 522, UL channel establishment module 112, calculation module 114, adjustment module 116, transmit power limit module 118, transmitter module 120, and the computer-readable medium 525. The bus 524 may also link various other circuits such as timing sources, peripherals, voltage regulators, and power management circuits, which are well known in the art, and therefore, will not be described any further.

The apparatus includes a processing system 514 coupled to a transceiver 530. The transceiver 530 is coupled to one or more antennas 520. The transceiver 530 enables communicating with various other apparatus over a transmission medium and, in an aspect, may be configured to communicate with transmitter module 120 to do so as described herein.

The processing system 514 includes a processor 522 coupled to a computer-readable medium 525. The processor 522 is responsible for general processing, including the execution of software stored on the computer-readable medium 525. The software, when executed by the processor 522, causes the processing system 514 to perform the various functions described for any particular apparatus, such as, for example, the functions described herein with respect to UE 110 and/or its components. The computer-readable medium 525 may also be used for storing data that is manipulated by the processor 522 when executing software.

The processing system 514 includes a UL channel establishment module 112 for establishing a first uplink channel with a base station, such as, for example, base station 130, and establishing a second uplink channel with the base station, such as, for example, base station 130. UL channel establishment module 112 may be configured to establish the first uplink channel and the second uplink channel, such that they are in one timeslot and in the same frequency band. The processing system 514 includes calculation module 114 for calculating a difference between a transmission power of a first uplink channel and a transmission power of a second uplink channel. The processing system 514 includes adjustment module 116 for individually adjusting transmission power of the first uplink channel and the second uplink channel based on the calculated difference. The processing system 514 includes transmit power limit module 118 for determining an instantaneous transmit power limit of UE 110. The processing system 514 includes transmitter module 120 for transmitting information on a first uplink channel and a second uplink channel.

The modules 112-120 may be software modules running in the processor 522, resident/stored in the computer readable medium 525, one or more hardware modules coupled to the processor 522, or some combination thereof. In an aspect, the processing system 514 may be a component of the UE 110.

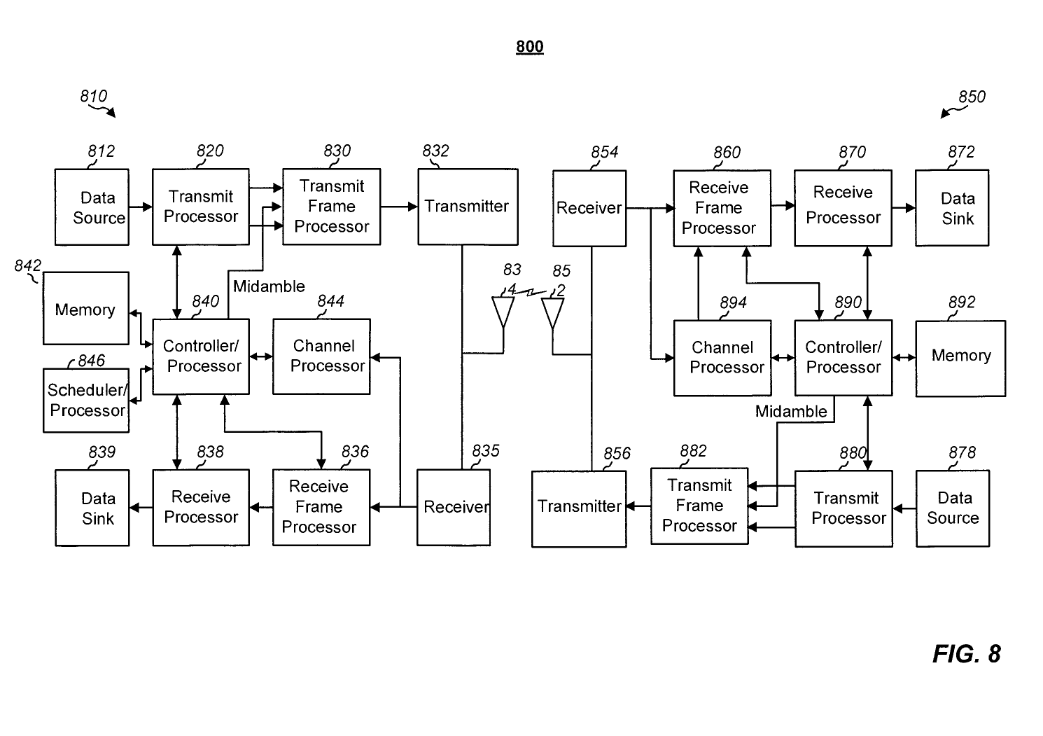

In one configuration, an apparatus, such as UE 110, is configured for wireless communication including means for establishing uplink channels, means for calculating, and means for individually adjusting transmission power. In one aspect, the means may be the channel processor 894, the transmit frame processor 882, the transmit processor 880, the controller/processor 890, the memory 892, power adjustment module 891, each of FIG. 8, UL channel establishment module 112, calculation module 114, adjustment module 116, transmit power limit module 118, transmitter module 120 and/or the processing system 514 configured to perform the functions recited by the aforementioned means. In another aspect, the aforementioned means may be a module or any apparatus configured to perform the functions recited by the aforementioned means.

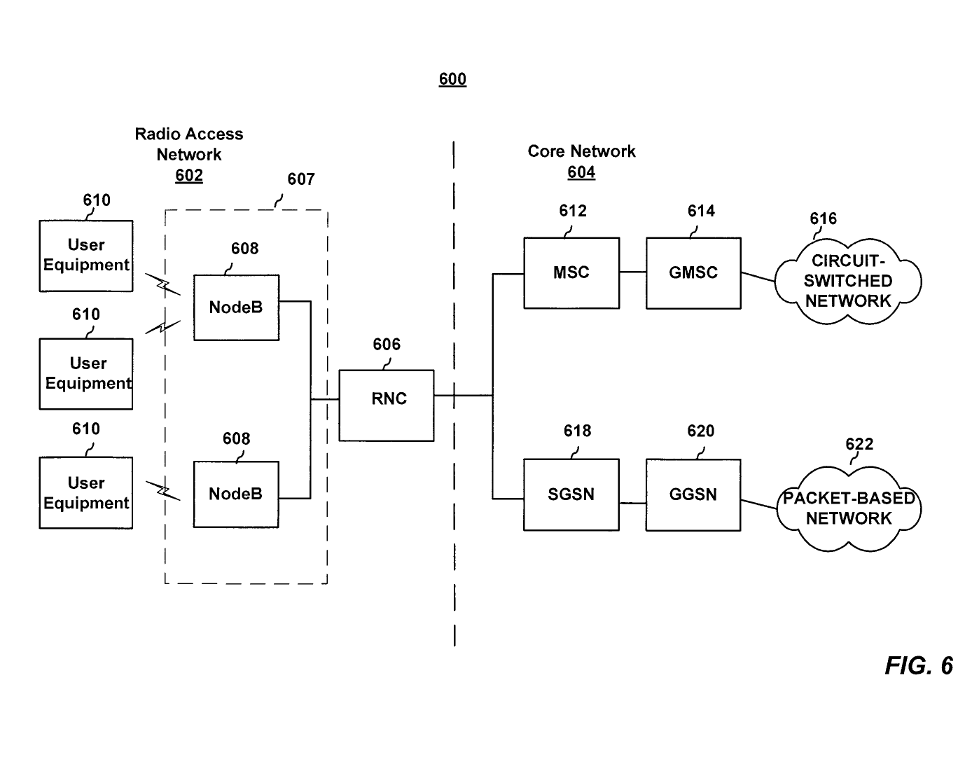

Referring to FIG. 6, a block diagram is shown illustrating an example of a telecommunications system 600 in which UE 110 of FIG. 1 may operate, wherein UEs 610 may be the same as or similar to UE 110. The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system employing a TD-SCDMA standard. In this example, the UMTS system includes a (radio access network) RAN 602 (e.g., UTRAN) that provides various wireless services including telephony, video, data, messaging, broadcasts, and/or other services. The RAN 602 may be divided into a number of Radio Network Subsystems (RNSs) such as an RNS 607, each controlled by a Radio Network Controller (RNC) such as an RNC 606. For clarity, only the RNC 606 and the RNS 607 are shown; however, the RAN 602 may include any number of RNCs and RNSs in addition to the RNC 606 and RNS 607. The RNC 606 is an apparatus responsible for, among other things, assigning, reconfiguring and releasing radio resources within the RNS 607. The RNC 606 may be interconnected to other RNCs (not shown) in the RAN 602 through various types of interfaces such as a direct physical connection, a virtual network, or the like, using any suitable transport network.

The geographic region covered by the RNS 607 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 608 are shown; however, the RNS 607 may include any number of wireless Node Bs. Node Bs 608 may be, in an aspect, base station 130 of FIG. 1. The Node Bs 608 provide wireless access points to a core network 604 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 610 are shown in communication with the Node Bs 608. UEs 610 may be UE 110 of FIG. 1. The downlink (DL), also called the forward link, refers to the communication link from a Node B to a UE, and the uplink (UL), also called the reverse link, refers to the communication link from a UE to a Node B.

The core network 604, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 604 supports circuit-switched services with a mobile switching center (MSC) 612 and a gateway MSC (GMSC) 614. One or more RNCs, such as the RNC 606, may be connected to the MSC 612. The MSC 612 is an apparatus that controls call setup, call routing, and UE mobility functions. The MSC 612 also includes a visitor location register (VLR) (not shown) that contains subscriber-related information for the duration that a UE is in the coverage area of the MSC 612. The GMSC 614 provides a gateway through the MSC 612 for the UE to access a circuit-switched network 616. The GMSC 614 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 614 queries the HLR to determine the UE's location and forwards the call to the particular MSC serving that location.

The core network 604 also supports packet-data services with a serving GPRS support node (SGSN) 618 and a gateway GPRS support node (GGSN) 620. GPRS, which stands for General Packet Radio Service, is designed to provide packet-data services at speeds higher than those available with standard GSM circuit-switched data services. The GGSN 620 provides a connection for the RAN 602 to a packet-based network 622. The packet-based network 622 may be the Internet, a private data network, or some other suitable packet-based network. The primary function of the GGSN 620 is to provide the UEs 610 with packet-based network connectivity. Data packets are transferred between the GGSN 620 and the UEs 610 through the SGSN 618, which performs primarily the same functions in the packet-based domain as the MSC 612 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 608 and a UE 610, but divides uplink and downlink transmissions into different time slots in the carrier.

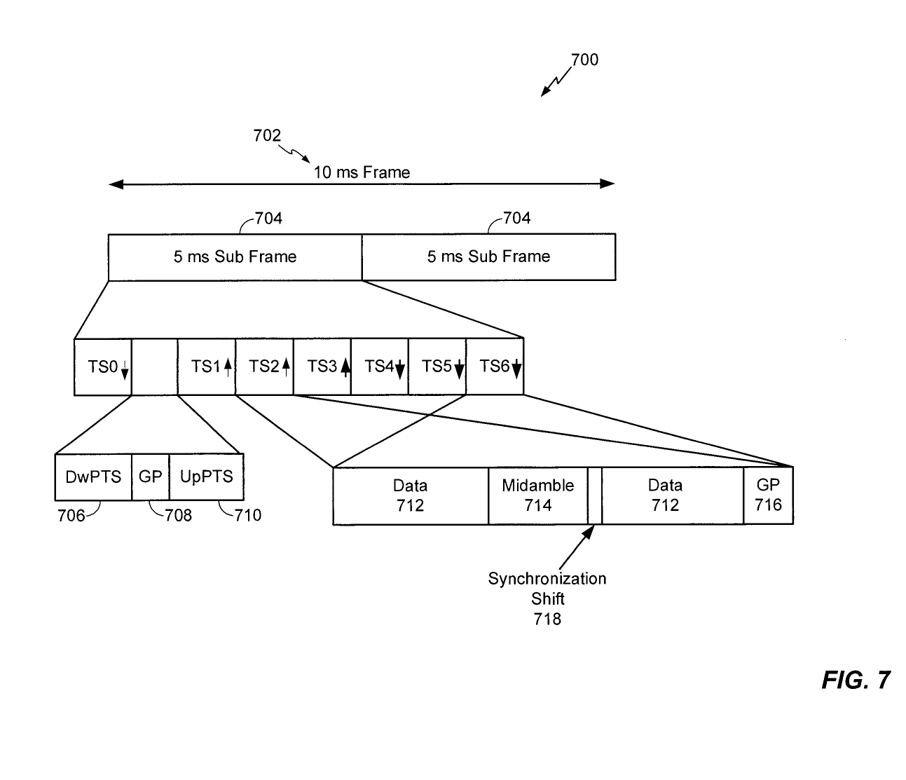

FIG. 7 shows a frame structure 700 for a TD-SCDMA carrier, which may be used in communications between base station 130 and/or UE 110 of FIG. 1. The TD-SCDMA carrier, as illustrated, has a frame 702 that is 10 ms in length. The chip rate in TD-SCDMA is 1.28 Megachips per second (Mcps). The frame 702 has two 5 ms subframes 704, and each of the subframes 704 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 706, a guard period (GP) 708, and an uplink pilot time slot (UpPTS) 710 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 712 (each with a length of 352 chips) separated by a midamble 714 (with a length of 144 chips) and followed by a guard period (GP) 716 (with a length of 16 chips). The midamble 714 may be used for features, such as channel estimation, while the guard period 716 may be used to avoid inter-burst interference. Also transmitted in the data portion is some Layer 1 control information, including Synchronization Shift (SS) bits 718. Synchronization Shift bits 718 only appear in the second part of the data portion. The Synchronization Shift bits 718 immediately following the midamble can indicate three cases: decrease shift, increase shift, or do nothing in the upload transmit timing. The positions of the SS bits 718 are not generally used during uplink communications.

FIG. 8 is a block diagram of a Node B 810 in communication with a UE 850 in a RAN 800, where the RAN 800 may be the RAN 602 of FIG. 6, the Node B 810 may be the Node B 608 of FIG. 6 and/or the base station 130 of FIG. 1, and the UE 850 may be the UE 610 of FIG. 6 and/or UE 110 of FIG. 1. In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback contained in the midamble 714 (FIG. 7) from the UE 850. The symbols generated by the transmit processor 820 are provided to a transmit frame processor 830 to create a frame structure. The transmit frame processor 830 creates this frame structure by multiplexing the symbols with a midamble 714 (FIG. 7) from the controller/processor 840, resulting in a series of frames. The frames are then provided to a transmitter 832, which provides various signal conditioning functions including amplifying, filtering, and modulating the frames onto a carrier for downlink transmission over the wireless medium through smart antennas 834. The smart antennas 834 may be implemented with beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides the midamble 714 (FIG. 7) to a channel processor 894 and the data, control, and reference signals to a receive processor 870. The receive processor 870 then performs the inverse of the processing performed by the transmit processor 820 in the Node B 810. More specifically, the receive processor 870 descrambles and despreads the symbols, and then determines the most likely signal constellation points transmitted by the Node B 810 based on the modulation scheme. These soft decisions may be based on channel estimates computed by the channel processor 894. The soft decisions are then decoded and deinterleaved to recover the data, control, and reference signals. The CRC codes are then checked to determine whether the frames were successfully decoded. The data carried by the successfully decoded frames will then be provided to a data sink 872, which represents applications running in the UE 850 and/or various user interfaces (e.g., display). Control signals carried by successfully decoded frames will be provided to a controller/processor 890. When frames are unsuccessfully decoded by the receiver processor 870, the controller/processor 890 may also use an acknowledgement (ACK) and/or negative acknowledgement (NACK) protocol to support retransmission requests for those frames.

In the uplink, data from a data source 878 and control signals from the controller/processor 890 are provided to a transmit processor 880. The data source 878 may represent applications running in the UE 850 and various user interfaces (e.g., keyboard). Similar to the functionality described in connection with the downlink transmission by the Node B 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the Node B 810 or from feedback contained in the midamble transmitted by the Node B 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with a midamble 714 (FIG. 7) from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the Node B 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides the midamble 714 (FIG. 7) to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the Node B 810 and the UE 850, respectively. For example, the controller/processors 840 and 890 may provide various functions including timing, peripheral interfaces, voltage regulation, power management, and other control functions. The computer readable media of memories 842 and 892 may store data and software for the Node B 810 and the UE 850, respectively. For example, the memory 892 of the UE 850 may store power adjustment module 891 which, when executed by the controller/processor 890, configures the UE 850 to adjust the transmission power of an uplink channel or an enhanced high speed channel. A scheduler/processor 846 at the Node B 810 may be used to allocate resources to the UEs and schedule downlink and/or uplink transmissions for the UEs.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long- range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the FIGS. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for controlling transmission power of uplink channels, comprising:
establishing a first uplink channel with a base station;
establishing a second uplink channel with the base station, wherein the first uplink channel and the second uplink channel are in one timeslot and in the same frequency band;
calculating a difference between a transmission power of the first uplink channel and a transmission power of the second uplink channel; and
individually adjusting transmission power of the first uplink channel and transmission power of the second uplink channel based on the calculated difference.

2. The method of claim 1, wherein individually adjusting transmission power comprises:
determining that at least one of the first uplink channel or the second uplink channel are newly-established, wherein a newly-established uplink channel is a channel that was not previously detected by the base station; and
applying open-loop power control to the at least one of the first uplink channel or the second uplink channel based on the determination, wherein applying open-loop power control comprises using a pre-determined power level for transmission power control of the at least one of the first uplink channel or the second uplink channel.

3. The method of claim 1, wherein the first uplink channel is in open-loop power control or closed-loop power control, and the second uplink channel is in open-loop power control or closed-loop power control.

4. The method of claim 1, further comprising adjusting the transmission power of the first uplink channel and the transmission power of the second uplink channel based on a spreading factor of the first uplink channel and a spreading factor of the second uplink channel.

5. The method of claim 1,
wherein the transmission power of the first uplink channel is greater than the transmission power of the second uplink channel, and
further comprising adjusting the transmission power of the second uplink channel when the calculated difference is greater than a first threshold.

6. The method of claim 5, wherein individually adjusting transmission power comprises increasing the transmission power of the second uplink channel so that a difference between the transmission power of the second uplink channel and the transmission power of the first uplink channel is equal to or less than the first threshold.

7. The method of claim 5, wherein individually adjusting transmission power further comprises decreasing the transmission power of the first uplink channel so that a difference between the transmission power of the second uplink channel and the transmission power of the first uplink channel is equal to or less than a second threshold.

8. The method of claim 7, wherein decreasing the transmission power of the first uplink channel occurs when the first uplink channel is in open-loop power control and the second uplink channel is in closed-loop power control.

9. The method of claim 7, wherein individually adjusting transmission power further comprises setting the transmission power of the first uplink channel to a first pre-determined power level and setting the transmission power of the second uplink channel to a second pre-determined power level.

10. The method of claim 7, wherein individually adjusting transmission power further comprises setting the transmission power of the first uplink channel and the transmission power of the second uplink channel to be equal to or less than an instantaneous transmit power limit of a mobile device.

11. The method of claim 10, wherein the instantaneous transmit power limit is a difference between a maximum transmit power level of the mobile device and a maximum power ratio of the mobile device.

12. The method of claim 10, wherein individually adjusting transmission power is based, at least in part, on at least one of a channel type or whether the first uplink channel, the second uplink channel, or the first uplink channel and the second uplink channel are in open-loop or closed-loop power control.

13. A computer program product for controlling transmission power of uplink channels, comprising:
a computer-readable medium comprising:
code for causing a computer to:
establish a first uplink channel with a base station;
establish a second uplink channel with the base station, wherein the first uplink channel and the second uplink channel are in one timeslot and in the same frequency band;
calculate a difference between a transmission power of the first uplink channel and a transmission power of the second uplink channel; and
individually adjust transmission power of the first uplink channel and transmission power of the second uplink channel based on the calculated difference.

14. An apparatus for controlling transmission power of uplink channels, comprising:
means for establishing a first uplink channel with a base station;
means for establishing a second uplink channel with the base station, wherein the first uplink channel and the second uplink channel are in one timeslot and in the same frequency band;
means for calculating a difference between a transmission power of the first uplink channel and a transmission power of the second uplink channel; and
means for individually adjusting transmission power of the first uplink channel and transmission power of the second uplink channel based on the calculated difference.

15. An apparatus for controlling transmission power of uplink channels, comprising:
at least one memory;
an uplink channel establishment module configured to:
establish a first uplink channel with a base station, and
establish a second uplink channel with the base station, wherein the first uplink channel and the second uplink channel are in one timeslot and in the same frequency band;
a calculation module configured to calculate a difference between a transmission power of the first uplink channel and a transmission power of the second uplink channel; and
an adjustment module configured to individually adjust transmission power of the first uplink channel and transmission power of the second uplink channel based on the calculated difference.

16. The apparatus of claim 15, wherein the adjustment module being configured to individually adjust transmission power comprises the adjustment module configured to:
determine that at least one of the first uplink channel or the second uplink channel are newly-established, wherein a newly-established uplink channel is a channel that was not previously detected by the base station; and
apply open-loop power control to the at least one of the first uplink channel or the second uplink channel based on the determination, wherein the adjustment module being configured to apply open-loop power control comprises the adjustment module being configured to use a pre-determined power level for transmission power control of the at least one of the first uplink channel or the second uplink channel.

17. The apparatus of claim 15, wherein the first uplink channel is in open-loop power control or closed-loop power control, and the second uplink channel is in open-loop power control or closed-loop power control.

18. The apparatus of claim 15, wherein the adjustment module being configured to individually adjust transmission power further comprises the adjustment module configured to adjust the transmission power of the first uplink channel and the transmission power of the second uplink channel based on a spreading factor of the first uplink channel and a spreading factor of the second uplink channel.

19. The apparatus of claim 15,
wherein the transmission power of the first uplink channel is greater than the transmission power of the second uplink channel, and
wherein the adjustment module is further configured to adjust the transmission power of the second uplink channel when the calculated difference is greater than a first threshold.

20. The apparatus of claim 19, wherein the adjustment module being configured to individually adjust transmission power comprises the adjustment module being configured to increase the transmission power of the second uplink channel so that a difference between the transmission power of the second uplink channel and the transmission power of the first uplink channel is equal to or less than the first threshold.

21. The apparatus of claim 19, wherein the adjustment module being configured to individually adjust transmission power comprises the adjustment module being configured to decrease the transmission power of the first uplink channel so that a difference between the transmission power of the second uplink channel and the transmission power of the first uplink channel is equal to or less than a second threshold.

22. The apparatus of claim 21, wherein the adjustment module being configured to decrease the transmission power comprises the adjustment module being configured to decrease the transmission power of the first uplink channel occurs when the first uplink channel is in open-loop power control and the second uplink channel is in closed-loop power control.

23. The apparatus of claim 21, wherein the adjustment module being configured to individually adjust transmission power comprises the adjustment module being configured to set the transmission power of the first uplink channel to a first pre-determined power level and set the transmission power of the second uplink channel to a second pre-determined power level.

24. The apparatus of claim 21, wherein the adjustment module being configured to individually adjust transmission power comprises the adjustment module being configured to set the transmission power of the first uplink channel and the transmission power of the second uplink channel to be equal to or less than an instantaneous transmit power limit of a mobile device.

25. The apparatus of claim 24, wherein the instantaneous transmit power limit is a difference between a maximum transmit power level of the mobile device and a maximum power ratio of the mobile device.

26. The apparatus of claim 24, wherein the adjustment module being configured to individually adjust transmission power comprises the adjustment module being configured to individually adjust transmission power based, at least in part, on at least one of a channel type or whether the first uplink channel, the second uplink channel, or the first uplink channel and the second uplink channel are in open-loop or closed-loop power control.
